(19) United States
(12) Patent Application Publication
(10) Pub. No.: US 2015/0187000 A1
(43) Pub. Date: Jul. 2, 2015

(54) COMPANION DEVICE CONFIGURED FOR USE WITH AN ELECTRONIC TRADING SYSTEM

(71) Applicant: TRADING TECHNOLOGIES INTERNATIONAL, INC., CHICAGO, IL (US)

(72) Inventors: Scott F. Singer, Green Oaks, IL (US); Farley Owens, Chicago, IL (US); Matthew J. Mantel, Elmhurst, IL (US)

(73) Assignee: TRADING TECHNOLOGIES INTERNATIONAL, INC., CHICAGO, IL (US)

(21) Appl. No.: 14/143,647

(22) Filed: Dec. 30, 2013

(51) Int. Cl. G06Q 40/04

(52) U.S. Cl. CPC G06Q 40/04

(57) ABSTRACT

Example methods, systems, and computer readable media are disclosed to enable a trading system using a trading device and a companion device. An example method includes identifying, at a first trading device, a first trading interface selected at a second trading device. The first trading interface includes first trading data. The example method includes displaying a first companion interface at the first trading device. The first companion interface is associated with the first trading interface. The example method includes determining whether to update the first companion interface or to display a second companion interface based on activity at the second trading device. The example method includes updating the first companion interface if the first trading data is altered at the first trading interface. The example method includes displaying a second companion interface at the first trading device if a second trading interface is selected at the second trading device. The second companion interface is associated with the second trading interface.

### BACKGROUND

An electronic trading system generally includes a trading device in communication with an electronic exchange. The electronic exchange sends information about a market, such as prices and quantities, to the trading device. The trading device sends messages, such as messages related to orders, to the electronic exchange. The electronic exchange attempts to match quantity of an order with quantity of one or more contra-side orders.

The trading device may include software that creates a trading interface and/or trading window. In general, a trading interface and/or trading window is a tool that enables a user to interact and exchange information with the electronic exchange. For example, a trading interface and/or window can enable a user to view market data, submit a trade order to the electronic exchange, obtain a market quote, monitor a position, and/or combinations thereof.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIG. 4 illustrates a block diagram representative of another example electronic trading system in which certain embodiments may be employed.

FIG. 5 illustrates a flow diagram of an example method to facilitate trading activity via a trading interface at a trading device.

FIG. 6 illustrates a flow diagram of an example method to facilitate trading activity via a companion interface at a companion device.

FIG. 7 illustrates a flow diagram of an example method to implement a lock mode at a companion device.

FIG. 8 illustrates a flow diagram of an example method to execute trading activity at a trading device using a companion device.

FIG. 9 illustrates a flow diagram of another example method to execute trading activity at a trading device using a companion device.

FIG. 10 illustrates an example trading interface at a trading device implemented using the method of FIGS. 5 and/or 9.

FIG. 11 illustrates an example trading interface at a companion device implemented using the methods of FIGS. 6, 7, and/or 8.

FIG. 12 illustrates a block diagram of an example trading device to implement the methods of FIGS. 5 and/or 9.

FIG. 13 illustrates a block diagram of an example companion device to implement the methods of FIGS. 6, 7, and/or 8.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

Many different exchanges support electronic trading. Electronic trading allows a trader or trading application to interact with the exchanges from a remote location. Once connected to an exchange, the trader or trading application may receive market information about tradeable objects that are traded on the exchange. Market information may include bid prices, bid quantities, ask prices, ask quantities, prices and quantities for past sales, and/or other market related information. The trader or trading application may additionally trade the tradeable objects, such as by entering buy or sell orders.

A trading device may implement a trading interface and/or trading window to allow interaction with one or more markets. For example, a trading interface may allow a user (e.g., a trader) to obtain and view market data, set order entry parameters, submit order messages to an exchange, deploy trading algorithms, and/or monitor positions while implementing various trading strategies. A trading interface may provide, for example, a market depth ladder or market grid showing quantities available at an inside market and at other prices away from the inside market. Often, a plurality of trading interfaces are implemented at the trading device, and the user selects between the plurality of trading interfaces to interact with the market associated with the selected trading interface.

Examples disclosed and described herein provide a companion device to the trading device and the trading interface implemented thereon. In some examples, the companion device is operable with the trading device to implement an electronic trading system. In some examples, the trading device and the companion device work together to provide a trader with an improved trading environment where the companion device may dynamically display and update information related to activity at the trading device and may be used to control activity at the trading device.

In some examples, the companion device provides information associated with one or more trading interfaces implemented at the trading device. In some examples, as a user selects a trading interface and/or an element of a trading interface at a trading device, the companion device displays a companion interface associated with the selected trading interface and/or trading element. A trading interface may include trading element(s) and/or component(s) that make up the trading interface. The content and/or format of the companion interface displayed at the companion device may depend on the trading interface and/or trading element selected at the trading device. In other words, particular trading interface(s) and/or trading element(s) may be associated with particular companion interfaces.

In some examples, trading interface(s) and/or trading element(s) with a focus on a tradable object may be associated with companion interfaces providing information related to the tradeable object. For example, if a trading interface is selected at the trading device that is used to facilitate trades of a particular tradeable object, the companion interface associated with that trading interface includes information relevant to that particular tradeable object such as historical price charts, current price charts, lists of fills, lists of order activity, and details about current pricing (e.g., high prices, low prices, and close prices).

In some examples, trading interface(s) and/or trading element(s) with a focus on a trade order may be associated with companion interfaces providing information related to the trade order. For example, if a trading element is selected at the trading device that is related to a particular trade order, the companion interface associated with that trading element includes information relevant to that particular trade order such as transaction information, order history (e.g., actions implemented in association with the trade order), and tradeable object information.

In some examples, trading interface(s) and/or trading element(s) with a focus on a trade fill may be associated with companion interfaces providing information related to the trade fill. For example, if a trading element is selected at the trading device that is related to a particular trade fill, the companion interface associated with that trading element includes information relevant to that particular trade fill such as transaction information, order history (e.g., actions implemented in association with the trade fill), and tradeable object information.

In some examples, trading interface(s) and/or trading element(s) with a focus on user credentials may be associated with companion interfaces providing information related to the user credentials. For example, if a trading element is selected at the trading device that is related to credentials of a particular user, the companion interface associated with that trading element includes information relevant to those particular user credentials such as account information, customer accounts, default information, and contact information.

In some examples, as the user interacts with a trading interface at the trading device, the companion device dynamically updates the companion interface being displayed. For example, if the user initiates placement of an order via a trading interface at the trading device, the data displayed in the companion interface at the companion device may be updated to reflect the status of the placement of the order. Similarly, if the user receives updated data indicating that all or part of a placed order has been filled, then the trading interface at the trading device may be updated to reflect the status of the order while the companion interface may be updated to provide additional or more specific details contained within the updated data.

In some examples, as the user selects a new and/or different trading interface and/or trading element at the trading device, the companion device dynamically switches the companion interface to correspond to the selected new and/or different trading interface and/or trading element. In some examples, a lock mode may be implemented at the companion device such that when the user selects a new and/or different trading interface and/or trading element at the trading device, the companion device does not dynamically switch the companion interface and the companion interface displayed when the lock mode is implemented remains displayed on the companion device. The lock mode may be removed such that when the user selects a new and/or different trading interface and/or trading element at the trading device, the companion device dynamically switches the companion interface.

In some examples, the companion device is used to control the trading interface and/or trading element displayed at the trading device. For example, an indicator of a particular trading interface and/or trading element can be selected at the companion device and the companion device causes the trading device to display the selected trading interface and/or trading element. In some examples, a trading action (e.g., a trade order) may be implemented at the companion device and the companion device causes the trading device to execute the trading action and to update a corresponding trading interface and/or trading element according to the executed trading action.

Although this description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways.

### I. BRIEF DESCRIPTION OF CERTAIN EMBODIMENTS

Example methods, systems, and computer readable media are disclosed to enable a trading system using a trading device and a companion device. An example method includes identifying, at a first trading device, a first trading interface selected at a second trading device. The first trading interface includes first trading data. The example method includes displaying a first companion interface at the first trading device. The first companion interface is associated with the first trading interface. The example method includes determining whether to update the first companion interface or to display a second companion interface based on activity at the second trading device. The example method includes updating the first companion interface if the first trading data is altered at the first trading interface. The example method includes displaying a second companion interface at the first trading device if a second trading interface is selected at the second trading device. The second companion interface is associated with the second trading interface.

An example system includes a computing device configured to identify a first trading interface selected at a first trading device. The first trading interface includes first trading data. The example computing device is configured to display a first companion interface. The first companion interface is associated with the first trading interface. The example computing device is configured to determine whether to update the first companion interface or to display a second companion interface based on activity at the first trading device. The example computing device is configured to update the first companion interface if the first trading data is altered at the first trading interface. The example computing device is configured to display the second companion interface if a second trading interface is selected at the first trading device. The second companion interface is associated with the second trading interface.

An example tangible computer readable storage medium comprises instructions that, when executed, cause a computing device to identify, at a first trading device, a first trading interface selected at a second trading device. The first trading interface includes first trading data. The example instructions cause the computing device to display a first companion interface at the first trading device. The first companion interface is associated with the first trading interface. The example instructions cause the computing device to determine whether to update the first companion interface or to display a second companion interface based on activity at the second trading device. The example instructions cause the computing device to update the first companion interface if the first trading data is altered at the first trading interface. The example instructions cause the computing device to display a second companion interface at the first trading device if a second trading interface is selected at the second trading device. The second companion interface is associated with the second trading interface.

### II. EXAMPLE ELECTRONIC TRADING SYSTEM

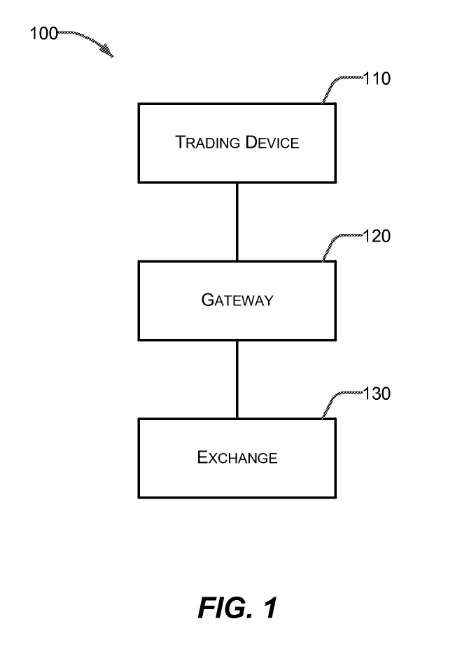

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication with” encompasses direct communication and/or indirect communication through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradeable objects to the exchange 130.

Market data may include data about a market for a tradeable object. For example, market data may include the inside market, market depth, last traded price (“LTP”), a last traded quantity (“LTQ”), or a combination thereof. The inside market refers to the highest available bid price (best bid) and the lowest available ask price (best ask or best offer) in the market for the tradeable object at a particular point in time (since the inside market may vary over time). Market depth refers to quantities available at price levels including the inside market and away from the inside market. Market depth may have “gaps” due to prices with no quantity based on orders in the market.

The price levels associated with the inside market and market depth can be provided as value levels which can encompass prices as well as derived and/or calculated representations of value. For example, value levels may be displayed as net change from an opening price. As another example, value levels may be provided as a value calculated from prices in two other markets. In another example, value levels may include consolidated price levels.

A tradeable object is anything which may be traded. For example, a certain quantity of the tradeable object may be bought or sold for a particular price. A tradeable object may include, for example, financial products, stocks, options, bonds, future contracts, currency, warrants, funds derivatives, securities, commodities, swaps, interest rate products, index-based products, traded events, goods, or a combination thereof. A tradeable object may include a product listed and/or administered by an exchange, a product defined by the user, a combination of real or synthetic products, or a combination thereof. There may be a synthetic tradeable object that corresponds and/or is similar to a real tradeable object.

An order message is a message that includes a trade order. A trade order may be, for example, a command to place an order to buy or sell a tradeable object; a command to initiate managing orders according to a defined trading strategy; a command to change, modify, or cancel an order; an instruction to an electronic exchange relating to an order; or a combination thereof.

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Ill. (“Trading Technologies”). As another example, the trading device 110 may be a server running a trading application providing automated trading tools such as ADL®, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, a group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device may be executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may be implemented utilizing computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a cellular network, a peer-to-peer network, a T1 line, a T3 line, an integrated services digital network (“ISDN”) line, a point-of-presence, the Internet, a shared memory system and/or a proprietary network such as TTNET™ provided by Trading Technologies, for example.

The gateway 120 may include one or more electronic computing platforms. For example, the gateway 120 may be implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a wireless network, a virtual private network, a cellular network, a peer-to-peer network, a T1 line, a T3 line, an ISDN line, a point-of-presence, the Internet, a shared memory system, and/or a proprietary network such as TTNET™ provided by Trading Technologies, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may include an electronic matching system, such as a computer, server, or other computing device, which is adapted to allow tradeable objects, for example, offered for trading by the exchange, to be bought and sold. The exchange 130 may include separate entities, some of which list and/or administer tradeable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradeable objects. Unmatched trade orders may be listed for trading by the exchange 130. Once an order to buy or sell a tradeable object is received and confirmed by the exchange, the order is considered to be a working order until it is filled or cancelled. If only a portion of the quantity of the order is matched, then the partially filled order remains a working order. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. EXPANDED EXAMPLE ELECTRONIC TRADING SYSTEM

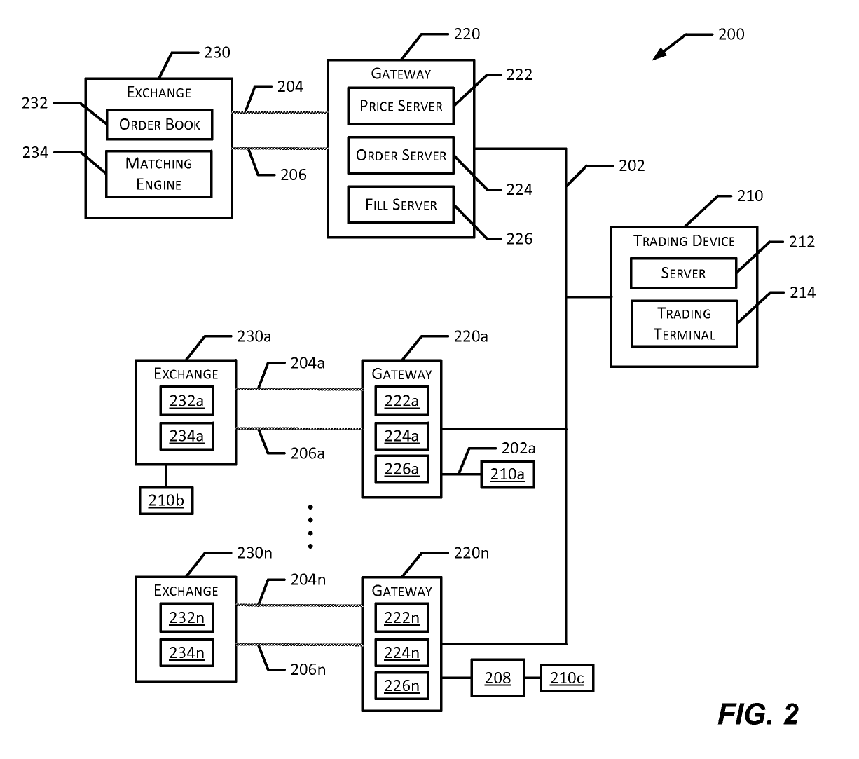

FIG. 2 illustrates a block diagram of another example electronic trading system 200 in which certain embodiments may be employed. In this example, a trading device 210 may utilize one or more communication networks to communicate with a gateway 220 and exchange 230. For example, the trading device 210 utilizes network 202 to communicate with the gateway 220, and the gateway 220, in turn, utilizes the networks 204 and 206 to communicate with the exchange 230. As used herein, a network facilitates or enables communication between computing devices such as the trading device 210, the gateway 220, and the exchange 230.

The following discussion generally focuses on the trading device 210, gateway 220, and the exchange 230. However, the trading device 210 may also be connected to and communicate with “n” additional gateways (individually identified as gateways 220a-220n, which may be similar to gateway 220) and “n” additional exchanges (individually identified as exchanges 230a-230n, which may be similar to exchange 230) by way of the network 202 (or other similar networks). Additional networks (individually identified as networks 204a-204n and 206a-206n, which may be similar to networks 204 and 206, respectively) may be utilized for communications between the additional gateways and exchanges. The communication between the trading device 210 and each of the additional exchanges 230a-230n need not be the same as the communication between the trading device 210 and exchange 230. Generally, each exchange has its own preferred techniques and/or formats for communicating with a trading device, a gateway, the user, or another exchange. It should be understood that there is not necessarily a one-to-one mapping between gateways 220a-220n and exchanges 230a-230n. For example, a particular gateway may be in communication with more than one exchange. As another example, more than one gateway may be in communication with the same exchange. Such an arrangement may, for example, allow one or more trading devices 210 to trade at more than one exchange (and/or provide redundant connections to multiple exchanges).

Additional trading devices 210a-210n, which may be similar to trading device 210, may be connected to one or more of the gateways 220a-220n and exchanges 230a-230n. For example, the trading device 210a may communicate with the exchange 230a via the gateway 220a and the networks 202a, 204a and 206a. In another example, the trading device 210b may be in direct communication with exchange 230a. In another example, trading device 210c may be in communication with the gateway 220n via an intermediate device 208 such as a proxy, remote host, or WAN router.

The trading device 210, which may be similar to the trading device 110 in FIG. 1, includes a server 212 in communication with a trading terminal 214. The server 212 may be located geographically closer to the gateway 220 than the trading terminal 214 in order to reduce latency. In operation, the trading terminal 214 may provide a trading screen to a user and communicate commands to the server 212 for further processing. For example, a trading algorithm may be deployed to the server 212 for execution based on market data. The server 212 may execute the trading algorithm without further input from the user. In another example, the server 212 may include a trading application providing automated trading tools and communicate back to the trading terminal 214. The trading device 210 may include additional, different, or fewer components.

In operation, the network 202 may be a multicast network configured to allow the trading device 210 to communicate with the gateway 220. Data on the network 202 may be logically separated by subject such as, for example, by prices, orders, or fills. As a result, the server 212 and trading terminal 214 can subscribe to and receive data such as, for example, data relating to prices, orders, or fills, depending on their individual needs.

The gateway 220, which may be similar to the gateway 120 of FIG. 1, may include a price server 222, order server 224, and fill server 226. The gateway 220 may include additional, different, or fewer components. The price server 222 may process price data. Price data includes data related to a market for one or more tradeable objects. The order server 224 processes order data. Order data is data related to a user's trade orders. For example, order data may include order messages, confirmation messages, or other types of messages. The fill server collects and provides fill data. Fill data includes data relating to one or more fills of trade orders. For example, the fill server 226 may provide a record of trade orders, which have been routed through the order server 224, that have and have not been filled. The servers 222, 224, and 226 may run on the same machine or separate machines. There may be more than one instance of the price server 222, the order server 224, and/or the fill server 226 for gateway 220. In certain embodiments, the additional gateways 220a-220n may each includes instances of the servers 222, 224, and 226 (individually identified as servers 222a-222n, 224a-224n, and 226a-226n).

The gateway 220 may communicate with the exchange 230 using one or more communication networks. For example, as shown in FIG. 2, there may be two communication networks connecting the gateway 220 and the exchange 230. The network 204 may be used to communicate market data to the price server 222. In some instances, the exchange 230 may include this data in a data feed that is published to subscribing devices. The network 206 may be used to communicate order data to the order server 224 and the fill server 226. The network 206 may also be used to communicate order data from the order server 224 to the exchange 230.

The exchange 230, which may be similar to the exchange 130 of FIG. 1, includes an order book 232 and a matching engine 234. The exchange 230 may include additional, different, or fewer components. The order book 232 is a database that includes data relating to unmatched trade orders that have been submitted to the exchange 230. For example, the order book 232 may include data relating to a market for a tradeable object, such as the inside market, market depth at various price levels, the last traded price, and the last traded quantity. The matching engine 234 may match contra-side bids and offers pending in the order book 232. For example, the matching engine 234 may execute one or more matching algorithms that match contra-side bids and offers. A sell order is contra-side to a buy order. Similarly, a buy order is contra-side to a sell order. A matching algorithm may match contra-side bids and offers at the same price, for example. In certain embodiments, the additional exchanges 230a-230n may each include order books and matching engines (individually identified as the order book 232a-232n and the matching engine 234a-234n, which may be similar to the order book 232 and the matching engine 234, respectively). Different exchanges may use different data structures and algorithms for tracking data related to orders and matching orders.

In operation, the exchange 230 may provide price data from the order book 232 to the price server 222 and order data and/or fill data from the matching engine 234 to the order server 224 and/or the fill server 226. Servers 222, 224, 226 may process and communicate this data to the trading device 210. The trading device 210, for example, using a trading application, may process this data. For example, the data may be displayed to a user. In another example, the data may be utilized in a trading algorithm to determine whether a trade order should be submitted to the exchange 230. The trading device 210 may prepare and send an order message to the exchange 230.

In certain embodiments, the gateway 220 is part of the trading device 210. For example, the components of the gateway 220 may be part of the same computing platform as the trading device 210. As another example, the functionality of the gateway 220 may be performed by components of the trading device 210. In certain embodiments, the gateway 220 is not present. Such an arrangement may occur when the trading device 210 does not need to utilize the gateway 220 to communicate with the exchange 230, such as if the trading device 210 has been adapted to communicate directly with the exchange 230.

### IV. EXAMPLE COMPUTING DEVICE

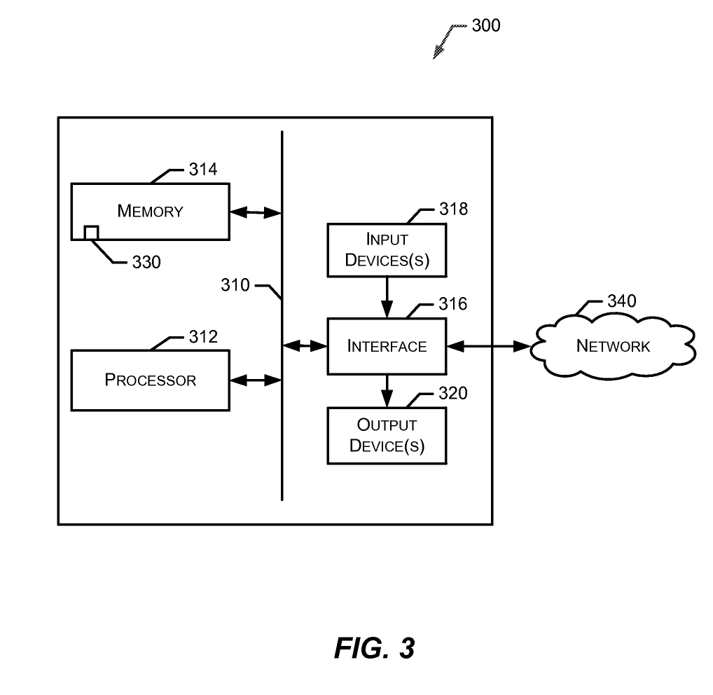

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, and magnetic tape or disk.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. EXAMPLE ELECTRONIC TRADING SYSTEMS AND METHODS INCLUDING A TRADING DEVICE AND AN ASSOCIATED COMPANION DEVICE

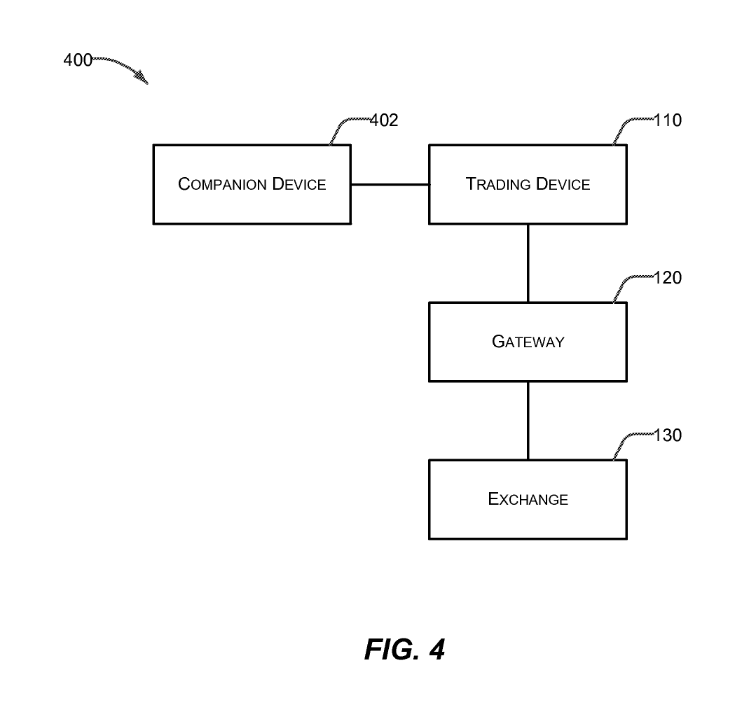

FIG. 4 illustrates a block diagram representative of an exemplary electronic trading system 400 in which certain embodiments may be employed. The system 400 includes the trading device 110, the gateway 120, and the exchange 130 of FIG. 1. The gateway 120 and the exchange 130 of FIG. 4 have been described above with reference to FIG. 1 and, thus, will not be described in detail with reference to FIG. 4. The system 400 further includes a companion device 402 in communication with the trading device 110. The trading device 110 may be, for example, a personal computer and the companion device may be, for example, a handheld computing device such as a tablet and smartphone. The trading device 110 and the companion device 402 are associated such that two-way communication between the devices is enabled. The trading device 110 and the companion device 402 may communicate via any wired and/or wireless connection. The trading device 110 and/or the companion device 402 may implement a process to recognize the other device and establish the association between the devices. The exemplary electronic trading system 400 depicted in FIG. 4 may be in communication with additional components, subsystems, and elements to provide additional functionality and capabilities without departing from the teaching and disclosure provided herein.

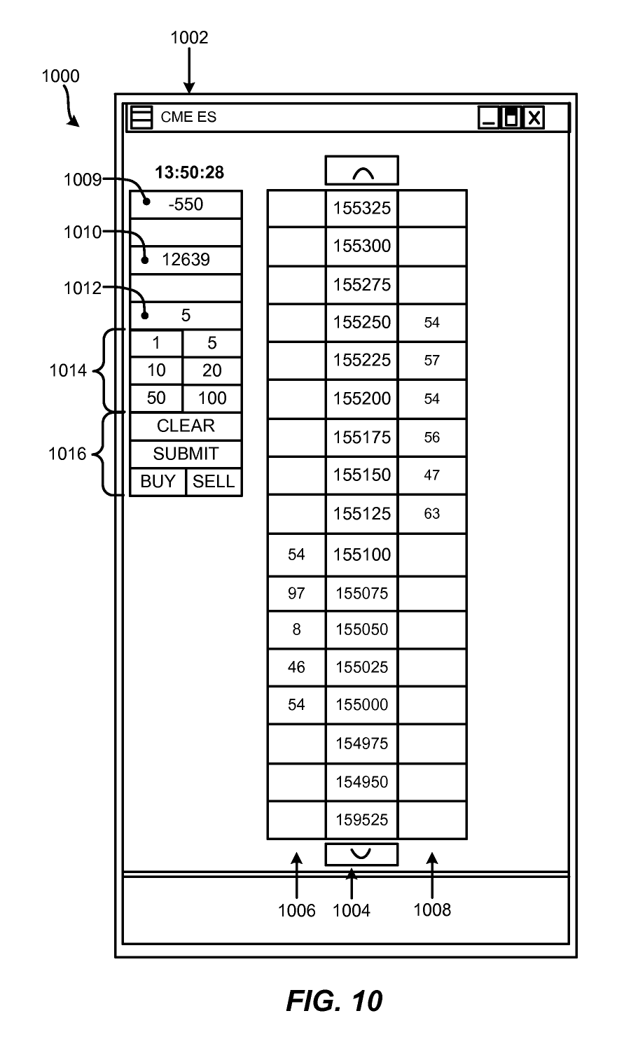

The trading device 110 may implement a trading interface and/or trading window to facilitate interaction with one or more markets. For example, a trading interface implemented at the trading device 110 may allow a user (e.g., a trader) to obtain and view market data, set order entry parameters, submit order messages to an exchange, deploy trading algorithms, and/or monitor positions while implementing various trading strategies. A trading interface may include trading elements and/or components that make up the trading interface. The trading elements and/or components may be selected by the user at the trading device 110 to control trading activity (e.g., obtaining market data, setting order entry parameters, submitting order message, and deploying trading algorithms) in the trading interface. The trading device 110 may include hardware and/or software configured to generate trading interfaces such as the example trading interface illustrated in FIG. 10.

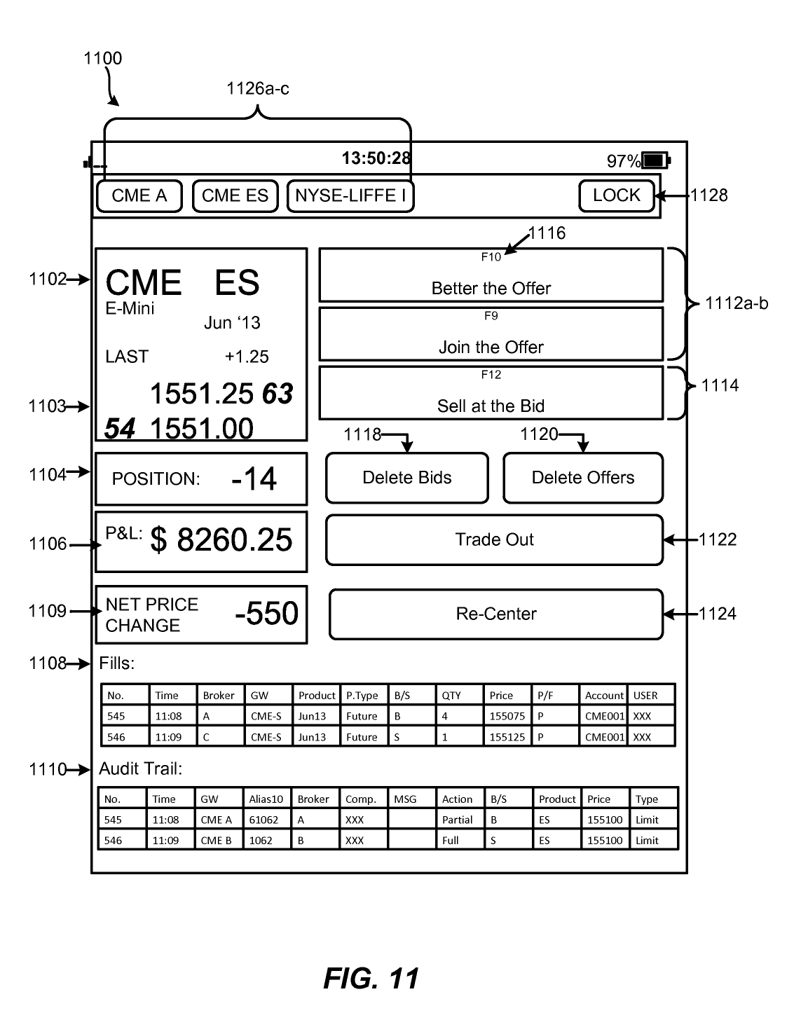

In the illustrated example, the example companion device 402 provides information associated with trading interfaces implemented at the trading device 110. In the illustrated example, as a user selects a trading interface and/or an element of a trading interface at the trading device 110, the companion device 402 displays a companion interface associated with the selected trading interface and/or trading element. The content and/or format of the companion interface displayed at the example companion device 402 may depend on the trading interface and/or trading element selected at the trading device 110. In other words, particular trading interfaces and/or trading elements may be associated with particular companion interfaces. The companion device 402 may include hardware and/or software configured to generate companion interfaces such as the example companion interface illustrated in FIG. 11.

In some examples, trading interfaces and/or trading elements with a focus on a tradable object may be associated with companion interfaces providing information related to the tradeable object. For example, if a trading interface is selected at the trading device 110 that is used to facilitate trades of a particular tradeable object, the companion interface associated with that trading interface displayed at the companion device 402 includes information relevant to that particular tradeable object such as historical price charts, current price charts, lists of fills, lists of order activity, and details about current pricing (e.g., high prices, low prices, and close prices).

In some examples, trading interfaces and/or trading elements with a focus on a trade order may be associated with companion interfaces providing information related to the trade order. For example, if a trading element is selected at the trading device 110 that is related to a particular trade order, the companion interface associated with that trading element displayed at the companion device 402 includes information relevant to that particular trade order such as transaction information, order history (e.g., actions implemented in association with the trade order), and tradeable object information.

In some examples, trading interfaces and/or trading elements with a focus on a trade fill may be associated with companion interfaces providing information related to the trade fill. For example, if a trading element is selected at the trading device 110 that is related to a particular trade fill, the companion interface associated with that trading element displayed at the companion device 402 includes information relevant to that particular trade fill such as transaction information, order history (e.g., actions implemented in association with the trade fill), and tradeable object information.

In some examples, trading interfaces and/or trading elements with a focus on user credentials may be associated with companion interfaces providing information related to the user credentials. For example, if a trading element is selected at the trading device 110 that is related to credentials of a particular user, the companion interface associated with that trading element displayed at the companion device 402 includes information relevant to those particular user credentials such as account information, customer accounts, default information, and contact information.

In the illustrated example, as the user interacts with a trading interface at the trading device 110, the companion device 402 dynamically updates the companion interface being displayed. For example, if the user executes a trader order in a trading interface at the trading device 110, the data displayed in the companion interface at the companion device 402 is updated to reflect the execution of the trade order. If the user fills a trade order in a trading interface at the trading device 110, the data displayed in the companion interface at the companion device 402 is updated to reflect the fill of the trade order.

In the illustrated example, as the user selects a new and/or different trading interface and/or trading element at the trading device 110, the companion device 402 dynamically switches the companion interface to correspond to the selected new and/or different trading interface and/or trading element. In some examples, a lock mode may be implemented at the companion device 402. The lock mode may be implemented at the companion device 402 by the user selecting a component or button in the companion interface corresponding to the lock mode, for example. The lock mode operates on the companion device 402 such that when the user selects a new and/or different trading interface and/or trading element at the trading device 110, the companion device 402 does not dynamically switch the companion interface and the companion interface displayed when the lock mode is implemented remains displayed on the companion device 402. The lock mode may be removed (e.g., by the user selecting an unlock mode) such that the when the user selects a new and/or different trading interface and/or trading element at the trading device 110, the companion device 402 dynamically switches the displayed companion interface.

In the illustrated example, the companion device 402 may be used to control the trading interface and/or trading elements displayed at the trading device 110. For example, an indicator of a particular trading interface and/or trading element can be selected at the companion device 402 and the companion device 402 causes the trading device 110 to display the selected trading interface and/or trading element. In some examples, a trading action (e.g., a trade order) may be implemented at the companion device 402 and the companion device 402 causes the trading device 110 to execute the trading action and to update a corresponding trading interface and/or trading element according to the executed trading action.

In some examples, the trading interfaces, trading elements, and/or companion interfaces are customizable. For example, a user can specify what information to include and how to display the information in the trading interfaces, trading elements, and/or companion interfaces. In some examples, default settings are used for the trading interfaces, trading elements, and/or companion interfaces.

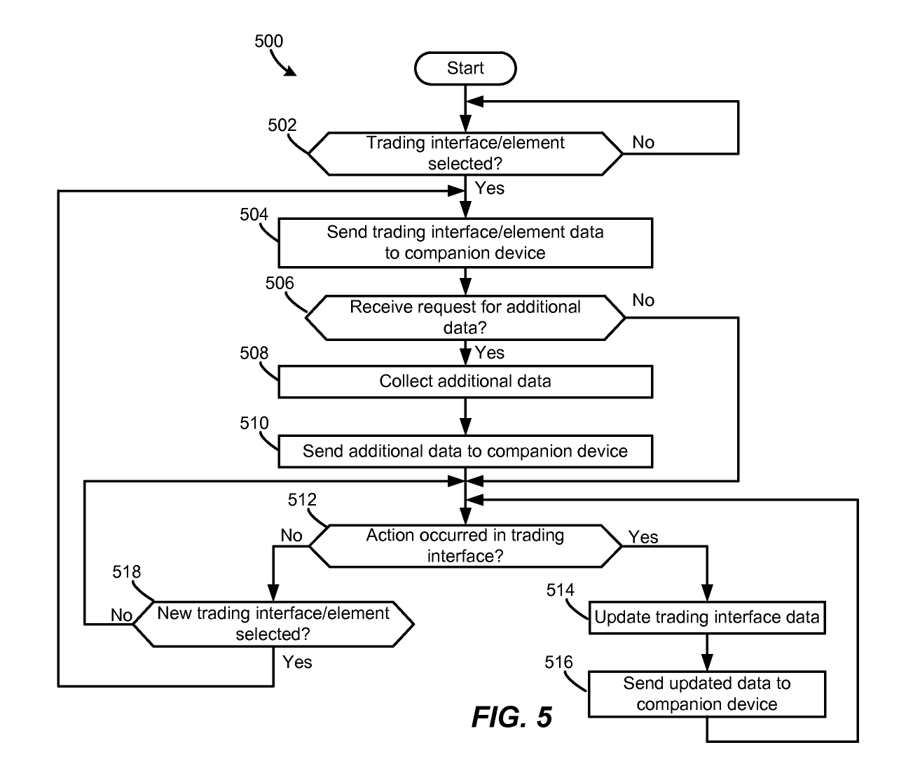

FIG. 5 illustrates a flow diagram of an example method 500 to facilitate trading activity via a trading interface at a trading device. A trading device may implement a trading interface and/or trading window to allow interaction with one or more markets. For example, a trading interface may allow a user (e.g., a trader) to obtain and view market data, set order entry parameters, submit order messages to an exchange, deploy trading algorithms, and/or monitor positions while implementing various trading strategies. A trading interface may include trading elements and/or components arranged, positioned and configured to present information and receive input from the user. The trading elements and/or components may be selected by the user at the trading device to control trading activity (e.g., obtaining market data, setting order entry parameters, submitting order message, and deploying trading algorithms) in the trading interface. In the illustrated example, the trading device is operable with a companion device to provide the user with additional information related to trading activity and to enable additional control over the trading activity. For example, the trading interface may provide information for a market as a whole while the companion interface allows for monitoring of and interaction with an element or tradeable object trading within the market. This configuration allows for efficient interaction with the market in multiple manners (i.e., the user can conduct market level analyses while monitoring individual parameters associated with a specific aspect or tradeable object.)

Initially, the trading device determines if a trading interface and/or a trading element has been selected (block 502). A trading interface and/or trading element may be represented by, for example, a selectable button or window, and may be selected at the trading device by a user using an input device such as a mouse, and keyboard. Control remains at block 502 until a trading interface and/or trading element is selected. When the trading device determines that a trading interface and/or trading element has been selected, control proceeds to block 504.

The trading device sends trading interface data and/or trading element data corresponding to the selected trading interface and/or trading element to the companion device (block 504). Trading interface data and/or trading element data may include, for example, an identifier of the particular type of trading interface and/or trading element, tradeable object data, historical price charts, current price charts, lists of fills, lists of order activity, pricing details, transaction information, order history, account information, default information, and contact information. The trading interface data and/or trading element data is used by the companion device to display a companion interface associated with the selected trading interface and/or trading element. In some examples, the trading interface data and/or trading element data provided to the companion device by the trading device may be insufficient for the companion device to display the companion interface. For example, the trading device can send an identifier of a trade order corresponding to a trade order selected at the trading device, but the companion device may desire and/or require additional information such as a price of the order placed to include in the companion interface to be displayed. In such an example, the companion device may send a request to the trading device for additional information and/or data.

The trading device determines if a request for additional information and/or data has been received from the companion device (block 506). If a request for additional information and/or data has not been received, control proceeds to block 512. If a request for additional information and/or data has been received from the companion device, the trading device collects the requested additional information and/or data (block 508). The trading device may collect the requested additional information from a database at the trading device. In some examples, the trading device collects the requested additional information from a gateway and/or an exchange. Once the trading device has collected the requested additional information and/or data (block 508), the trading device sends the requested information and/or data to the companion device that requested the information and/or data (block 510).

The trading device determines if an action has occurred in the trading interface (block 512). An action may occur in the trading interface when a user obtains market data, sets order entry parameters, submits order messages to an exchange, deploys trading algorithms, fills an order, and/or monitors positions while implementing various trading strategies. Actions occurring in the trading interface affect (e.g., change) the trading interface data and/or trading element data. If an action has occurred in the trading interface, the trading device updates the trading interface data and/or trading element data (block 514). Updating the trading interface data and/or trading element data may cause the trading device to update the display of the trading interface and/or the trading element. The trading device sends the updated trading interface data and/or trading element data to the companion device (block 516) to allow the companion device to update the associated companion interface being displayed. Control then returns to block 512 to allow the trading device to determine if another action has occurred in the trading interface.

If the trading device determines that no action has occurred in the trading interface (block 512), the trading device determines if a new trading interface and/or trading element has been selected (block 518). In some examples, the selection of a new trading interface and/or trading element causes the companion device to switch the companion interface being displayed. If a new trading interface and/or trading element is not selected at the trading device (block 518), control returns to block 512 to allow the trading device to determine if another action has occurred in the trading interface. If a new trading interface and/or trading element is selected at the trading device (block 518), control returns to block 504 and the trading device sends trading interface data and/or trading element data associated with the newly selected trading interface and/or trading element to the companion device.

For example, a trader at the trading device may wish to send a message to an exchange to place a trade order. The trader may select a trading interface associated with the exchange and may select a trading element to identify a quantity of a particular tradeable object to be included in the trade order and the trading device determines that the trading interface and trading element have been selected (block 502). When the trader selects the trading interface for the exchange and the trading element to identify a quantity of a particular tradeable object to be included in the trade order, the trading device sends trading interface and/or trading element data to the companion device indicating that the particular exchange has been selected in the trading interface and that a particular tradeable object is to be included in a trade order (block 504).

The companion device generates and displays a secondary or supplemental interface, such as a companion interface, that includes information such as order history, transaction information, tradeable object information, etc. For example, the companion device may be configured to display a companion interface detailing past orders for the particular tradeable object made by the trader, but the companion device may not store the order history data locally. Instead, the companion device may send a request for the order history data associated with a trader and a particular tradeable object. The trading device receives the request for the historical data (block 506), collects the historical data (block 508), and sends the requested historical data for the trader for the particular tradeable object to the companion device to enable the companion device to display the companion interface (block 510).

The trader may select to initiate sending of the trade order to the exchange and the trading device determines that a trading action occurred in the trading interface (block 512). The trading device updates the trading interface data according to the sending of the trade order (block 514) and sends the trading interface data indicating that the trade order has been sent to the companion device to enable the companion device to update the companion interface (block 516). The trader may then select a new trading interface, such as user credential interface associated with the trader. The trading device determines that the new trading interface has been selected (block 518) and sends trading interface data to the companion device indicating that the credential interface has been selected to enable the companion device to display a companion interface associated with the credential interface for the trader (block 504).

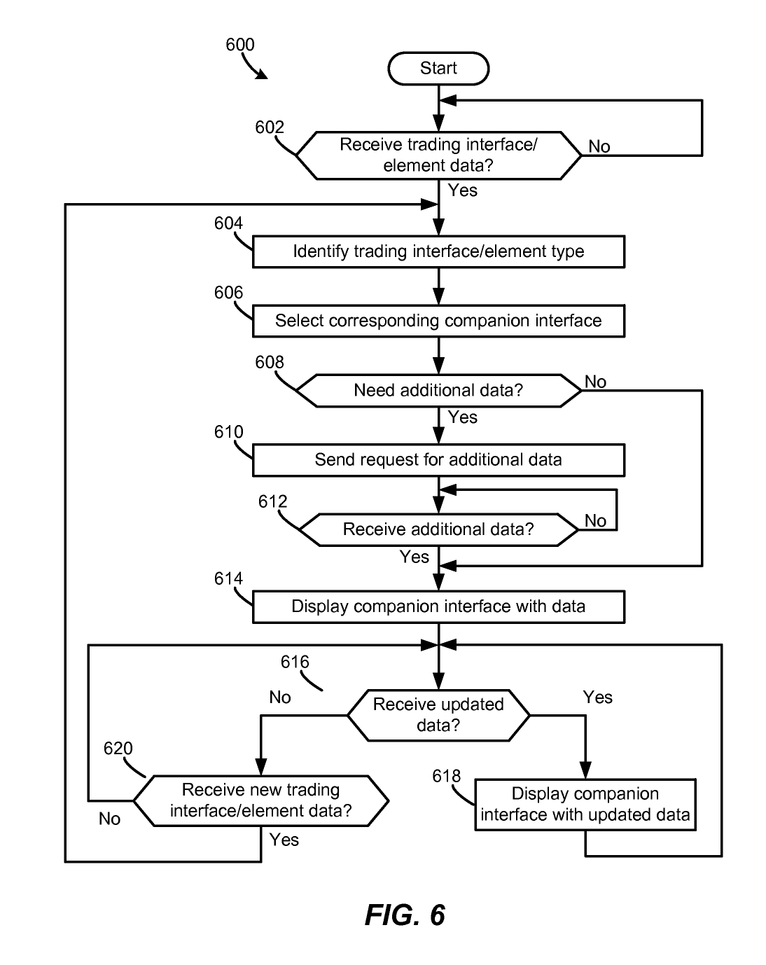

FIG. 6 illustrates a flow diagram of an example method 600 to facilitate trading activity via a secondary or supplemental interface such as a companion interface at a companion device. The secondary or supplemental interface is linked to the trading interface and configured to facilitate assimilation of trading information and/or initiate sending of a trade order. In the illustrated example, the companion device is operable with a trading device to provide a user with additional information related to trading activity at the trading device and to enable additional control over the trading activity at the trading device.

Initially, the companion device determines if trading interface data and/or trading element data has been received from the trading device (block 602). The trading interface data and/or trading element data corresponds to a trading interface and/or trading element selected at the trading device. Trading interface data and/or trading element data may include, for example, an identifier of the particular type of trading interface and/or trading element, tradeable object data, historical price charts, current price charts, lists of fills, lists of order activity, pricing details, transaction information, order history, account information, default information, and contact information. Control remains at block 602 until trading interface data and/or trading element data is received.

The companion device identifies a type of trading interface and/or trading element selected at the trading device using the trading interface data and/or the trading element data (block 604). For example, the companion device can identify the type of trading interface and/or trading element using an identifier included in the data received from the trading device. In the illustrated example, the companion device includes a database to store trading interface and/or trading element identifiers along with the corresponding type of trading interface and/or trading element.

The companion device selects a companion interface corresponding to the identified type of trading interface and/or trading element (block 606). In the illustrated example, the database at the companion device stores layouts for the various types of companion interfaces associated with the different types of selected trading interfaces and/or trading elements. The layouts for the various types of companion interfaces may define particular trading data to be included in the companion interface, location of particular trading data in the companion interface, control elements (e.g., selectable buttons) to be included in the companion interface. In some examples, companion interfaces to provide information related to a tradeable object include historical price charts, current price charts, lists of fills, lists of order activity, and details about current pricing (e.g., high prices, low prices, and close prices). In some examples, companion interfaces to provide information related to a trade order include transaction information, order history (e.g., actions implemented in association with the trade order), and tradeable object information. In some examples, companion interfaces to provide information related to a trade fill include transaction information, order history (e.g., actions implemented in association with the trade order), and tradeable object information. In some examples, companion interfaces to provide information related to user credentials may include account information, customer accounts, default information, and contact information.

The companion device determines if additional information and/or data is needed to implement the identified companion interface (block 608). In some examples, the trading interface data and/or trading element data provided by the trading device may be insufficient to create the companion interface associated with the trading interface and/or trading element selected at the trading device. For example, the trading device can send an identifier of a trade order interface corresponding to a trade order interface selected at the trading device, but the companion device may desire and/or require additional information such as a price of the order placed to include in the companion interface to be displayed.

If the companion device does not desire and/or require additional data and/or information (block 608), control proceeds to block 614. If the companion device does desire and/or require additional data and/or information (block 608), the companion device sends a request to the trading device for the additional data and/or information (block 610). In some examples, the companion device sends the request for the additional data and/or information to a gateway and/or an exchange.

The companion device determines if the requested additional data and/or information has been received (block 612). Control remains at block 612 until the additional data and/or information has been received. Once the additional data and/or information has been received, the companion device displays the companion interface with the appropriate trading interface data and/or trading element data (block 614).

The companion device may receive updated trading interface data and/or trading element data as trading activities or actions occur at the trading device. Trading actions may occur in a trading interface at the trading device when a user obtains market data, sets order entry parameters, submits order messages to an exchange, deploys trading algorithms, fills an order, and/or monitors positions while implementing various trading strategies. The companion device determines if updated trading interface data and/or trading element data has been received from the trading device (block 616).

If the companion device has received updated trading interface data and/or trading element data, the companion device displays the companion interface with the updated trading interface data and/or trading element data (e.g., the companion device updates the companion interface) (block 618). Control then returns to block 616 to allow the companion device to determine if additional updated data has been received.

If the companion device has not received updated trading interface data and/or trading element data (block 616), the companion device determines if new trading interface data and/or new trading element data has been received (block 620). New trading interface data and/or new trading element data indicates that a new trading interface and/or trading element has been selected at the trading device. If new trading interface data and/or new trading element data has not been received, control returns to block 616 to allow the companion device to determine if additional updated data has been received. If new trading interface data and/or new trading element data has been received (block 620), control returns to block 604 to allow the companion device to identify the new trading interface and/or trading element type.

For example, a trader at the trading device may wish to send a message to an exchange to place a trade order. The trader may select a trading interface associated with the exchange and may select a trading element to identify a quantity of a particular tradeable object to be included in the trade order. When the trader selects the trading interface for the exchange and the trading element to identify a quantity of a particular tradeable object to be included in the trade order, the trading device sends trading interface and/or trading element data to the companion device indicating that the particular exchange has been selected in the trading interface and that a particular tradeable object is to be included in a trade order.

The companion device receives the trading interface and/or trading element data (block 602) and identifies that the exchange and the quantity of the particular tradeable object have been selected in the trading interface at the trading device (block 604). The companion device selects a companion interface to be displayed using the identified exchange and tradeable object (block 606), but may determine that additional information is needed for the companion interface (block 608). For example, the companion device may be directed to display a companion interface detailing past orders for the particular tradeable object made by the trader, but the companion device may not have the necessary order history data. The companion device sends a request for the order history data for the trader for the particular tradeable object to the trading device (block 610). The trading device receives the request for the historical data, collects the historical data, and sends the requested historical data for the trader for the particular tradeable object to the companion device to enable the companion device to display the companion interface. The companion device receives the historical data (block 612) and displays the companion interface for the exchange and particular tradeable object including the historical data for the trader for the tradeable object (block 614).

The trader may send the trade order to the exchange at the trading device and the trading device sends trading interface data indicating that the trade order has been sent to the companion device to enable the companion device to update the companion interface. The companion device receives the updated trading interface data (block 616) and updates the companion interface reflecting that the trade order has been sent (block 618).

The trader may then select a new trading interface at the trading device, such as user credential interface associated with the trader. The trading device sends trading interface data to the companion device indicating that the credential interface has been selected to enable the companion device to display a companion interface associated with the credential interface for the trader. The companion device determines that new trading interface data has been received (block 620) and identifies that the credential interface has been selected using the new trading interface data (block 604). The companion device selects the companion interface corresponding to the credential interface (block 606), determines that no additional data is needed for the companion interface (block 608), and displays the corresponding companion interface (block 614).

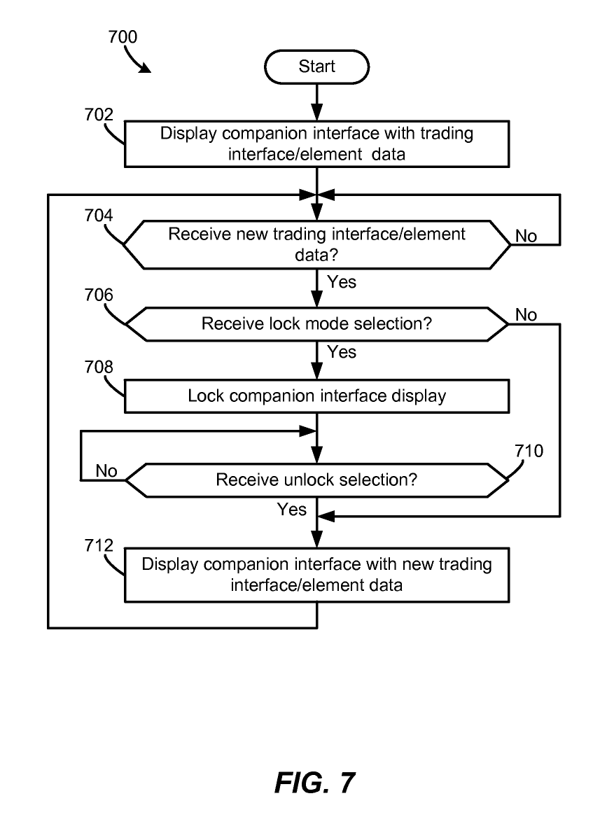

FIG. 7 illustrates a flow diagram of an example method 700 to implement a lock mode at a companion device. In some examples, as a user selects a new and/or different trading interface and/or trading element at a trading device, the companion device dynamically switches the companion interface being displayed to correspond to the selected new and/or different trading interface and/or trading element. In some examples, the user may wish to select a new and/or different trading interface and/or trading element at the trading device, but may wish for the companion interface displayed at the companion device to remain the same. For example, the user may wish to use the information displayed on the companion device for reference when interacting with a different trading interface and/or trading element at the trading device. To enable the companion interface to be continuously displayed at the companion device despite the selection of a different trading interface at the trading device, the companion device implements the lock mode.

Initially, the companion device displays a companion interface with trading interface data and/or trading element data (block 702). The companion device may display the companion interface associated with activity at a related or corresponding trading device using the method described above with reference to FIG. 6. The companion device determines if new trading interface data and/or trading element data has been received (block 704). The new trading interface data and/or trading element data indicates that a new trading interface and/or element has been selected at the trading device. Control remains at block 704 until new trading interface data and/or trading element data has been received.

Once new trading interface data and/or trading element data has been received, the companion device determines if a lock mode selection has been received (block 706). In some examples, the companion device provides a selectable lock mode button in the companion interface to enable a user to select the lock mode. If a lock mode selection has not been received, control proceeds to block 712. If a lock mode selection has been received, the companion device locks the display of the currently displayed companion interface (e.g., the companion interface being displayed when the lock mode was selected by the user) (block 708). By locking the companion interface, the companion device does not dynamically switch the companion interface being displayed even when data received from the trading device indicates that a new trading interface and/or trading element has been selected. In some examples, the companion device may not switch the display to a new companion interface, but may update data being displayed at the current companion interface based on data received from the trading device. In some examples, the companion device may dynamically display information provided to the companion interface while blocking or ignoring user inputs received that do not correspond to an unlock selection.

The companion device determines if an unlock mode selection has been received (block 710). In some examples, when the companion device is in a lock mode, the companion device provides a selectable unlock mode button in the companion interface to enable the user to select the unlock mode. Control remains at block 710 until an unlock mode selection has been received. If an unlock mode selection has been received, the companion device displays a new companion interface corresponding to the new trading interface data and/or trading element data received from the trading device (block 712). Control then returns to block 704 where the companion device determines if new trading interface data and/or trading element data has been received.

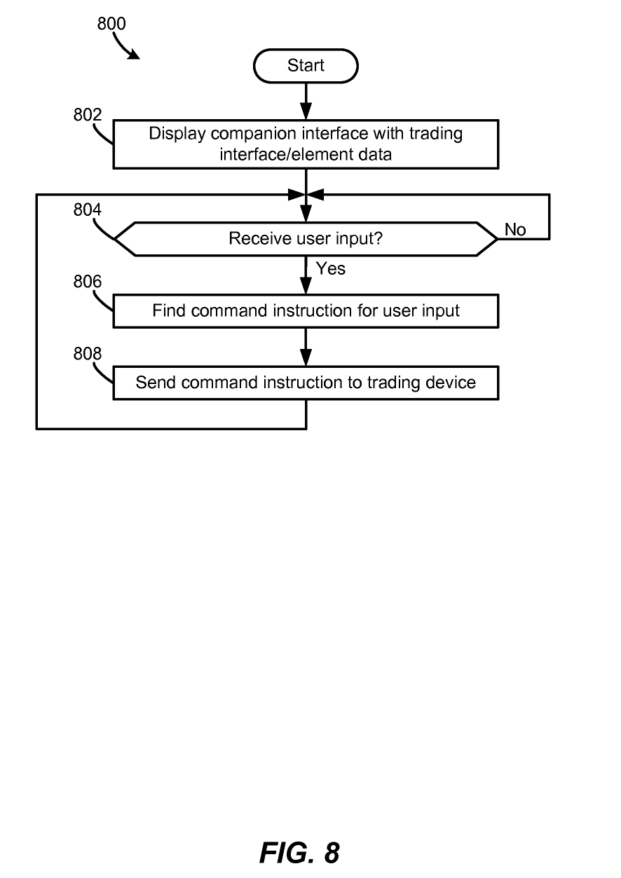

FIG. 8 illustrates a flow diagram of an example method 800 to execute trading activity at a trading device using a companion device. Trading activity may include, for example, obtaining and/or viewing market data, setting order entry parameters, submitting order messages to an exchange, deploying trading algorithms, and/or monitoring positions while implementing various trading strategies. Trading interfaces and/or trading elements within the trading interfaces facilitate trading activity at the trading device. In some examples, the companion device is used to control the trading interface and/or trading elements displayed at the trading device to perform trading activities. For example, an indicator of a particular trading interface and/or trading element can be selected at the companion device and the companion device causes the trading device to display the selected trading interface and/or trading element. In some examples, a trading action (e.g., submitting a trade order) may be implemented at the companion device and the companion device causes the trading device to execute the trading action and to update a corresponding trading interface and/or trading element according to the executed trading action.

Initially, the companion device displays a companion interface with trading interface data and/or trading element data (block 802). The companion device may display the companion interface associated with activity at a related or corresponding trading device using the method described above with reference to FIG. 6. The companion device determines if user input has been received (block 804). In some examples, the companion device provides selectable buttons and/or windows in the companion interface to enable a user to select commands, input parameters to execute trading activities or actions. Control remains at block 804 until user input is received.

Once user input has been received, the companion device finds command instructions associated with the user input (block 806). In some examples, a database at the companion device stores user inputs and command instructions associated with the user input. For example, if a user selects a button in the companion interface to submit a trading order, the companion device searches the database for a command instruction to provide to the trading device to cause the trading device to submit the trade order according to the user input. Once the companion device finds the command instruction for the user input, the companion device sends the command instruction to the trading device to cause the trading device to execute the command instruction (block 808). Control then returns to block 804 to allow the companion device to receive additional user input.

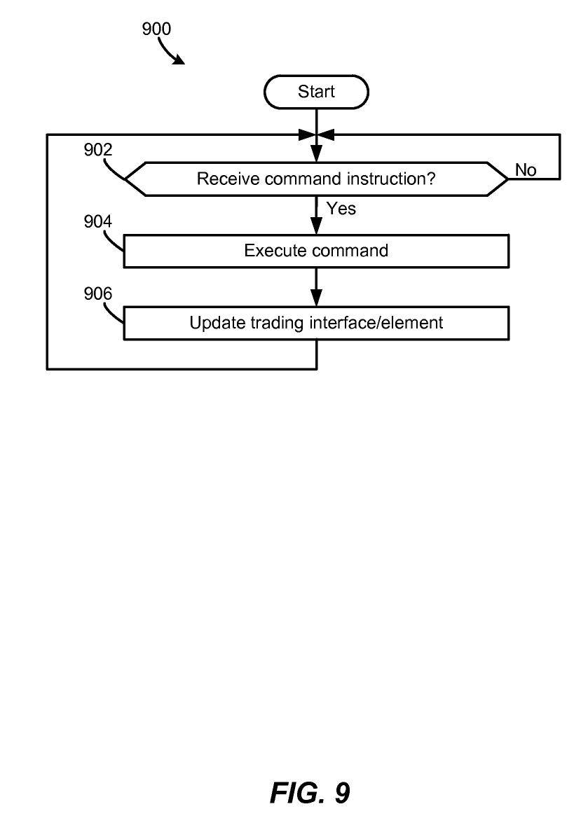

FIG. 9 illustrates a flow diagram of an example method 900 for executing trading activity at a trading device using a companion device. Trading activity may include, for example, obtaining and/or viewing market data, setting order entry parameters, submitting order messages to an exchange, deploying trading algorithms, and/or monitoring positions while implementing various trading strategies. Trading interfaces and/or trading elements within the trading interfaces facilitate trading activity at the trading device. In some examples, the companion device is used to control the trading interface and/or trading elements displayed at the trading device to perform trading activities. For example, an indicator of a particular trading interface and/or trading element can be selected at the companion device and the companion device causes the trading device to display the selected trading interface and/or trading element. In some examples, a trading action (e.g., submitting a trade order) may be implemented at the companion device and the companion device causes the trading device to execute the trading action and to update a corresponding trading interface and/or trading element according to the executed trading action.

Initially, the trading device determines if a command instruction has been received (block 902). The command instruction is received from a companion device and is representative of a command to be executed by the trading device. Control remains at block 902 until a command instruction is received. Once a command instruction is received, the trading device executes the command associated with the command instruction (block 904). The command instruction may instruct the trading device to, for example, select a particular trading interface and/or trading element, obtain and/or view market data, set order entry parameters, submit order messages to an exchange, deploy trading algorithms, and/or monitor positions while implementing various trading strategies. The trading device performs the trading action or activity of the command instruction and updates a trading interface and/or trading element associated with the trading action or activity (block 906). The trading device updates the trading interface and/or trading element so that the most updated information is displayed at the trading device. Control then returns to block 902 and the trading device awaits receipt of additional command instructions.

FIG. 10 illustrates an example trading interface 1000 at a trading device implemented using the method of FIGS. 5 and/or 9. The example trading interface 1000 may be used to initiate sending of a trade order to an exchange and/or monitor positions while implementing various trading strategies. The example trading interface 1000 reflects price information related to a tradeable object available at the exchange. The tradeable object and/or the exchange is identified at a selectable interface bar 1002. Different value levels are shown in a value column 1004. Value levels may represent prices, derivatives or prices and any other representation of value. A buy column 1006 and a sell column 1008 may be aligned adjacent to one or both sides of the value column 1004 such that quantity information is displayed adjacent to a corresponding value level. The trading elements shown as selectable buttons in the illustrated example may be used to submit order messages for the tradeable object to the exchange.

In the illustrated example, the trading interface 1000 of FIG. 10 also displays a net price change 1009 of the tradeable object over a given amount of time (e.g., since the market opened on a given day). The example trading interface 1000 also includes a current market volume 1010 of the tradeable object (e.g., a number of lots that have been traded). Other examples include different and/or additional information.

The example trading interface 1000 also enables the user to execute trades of the tradeable object via the electronic exchange 130. In the illustrated example, the trading interface 1000 includes a quantity field 1012. The quantity field 1012 displays a quantity (e.g., 5) for an order that the user will send to market, and the user may adjust the quantity by selecting (e.g., via a mouse) one of a plurality of buttons 1014 adjacent to the quantity field 1012 or by entering a new value into the quantity field 1012. If the user selects one of the interface elements 1016, one or more trade activities or actions may be initiated. For example, if the user selects the interface element 1016, such as the button labeled “CLEAR” in the illustrated example, the quantity field 1012 is cleared (e.g., the quantity displayed in the quantity field 1012 is adjusted to be zero). Similarly, if the user selects one of the interface elements 1016, such as the button labeled “SUBMIT” in the illustrated example, a trade action that initiates the sending of a trade order having the quantity indicated in the quantity field 1012 may be sent to the market. In certain embodiments, the interface elements 1016 may include “BUY” and “SELL” buttons configured to initiate desired trade actions and activities.

FIG. 11 illustrates an example companion interface 1100 at a companion device implemented using the methods of FIGS. 6, 7, and/or 8. The example companion interface 1100 corresponds to the trading interface 1000 of FIG. 10 and provides information associated with the trading interface 1000. As a user selects a trading interface and/or trading element at the trading device (e.g., the trading interface 1000), the companion device displays a companion interface associated with the selected trading interface and/or trading element (e.g., the trading interface 1100). In the illustrated example, the interface bar 1002 of FIG. 10 is selected by a user to give the user control over the trading interface 1000, and the companion device displays the corresponding companion interface 1100.

The example companion interface 1100 includes a contract identifier 1102 of the tradeable object being traded or monitored by the trading interface 1000. The companion interface 1100 may further include inside market information 1103 corresponding to the quantity and value data displayed in columns 1004-1008 of FIG. 10. In certain embodiments, the companion interface 1100 may display net price change information 1109 over a current or otherwise defined time period similar to the net price change 1009 displayed in FIG. 10. In this way, the example companion interface 1100 may include the same information presented via the trading interface 1000. In certain examples, the companion interface 1100 may include additional information and presentations of information such as an overall position 1104 associated with the trading interface 1000. For example, the companion interface 1100 may includes a profit and loss value 1106 associated with the trading interface 1000. The example companion interface includes fill information 1108 and audit information 1110.

The example companion interface 1100 also includes selectable buttons to enable a user to control actions in the trading interface 1000. While the companion interface 1100 may include the same information and options presented via the trading interface 1000 shown in FIG. 10, the companion interface 1100 may include a variety of dedicated interface elements to allow direct access to functionality. For example, the example companion interface 1100 includes offer buttons 1112a-b to better the offer (e.g., to increase the offer or offer more) or join the offer (e.g., to offer at the same price) identified at the trading interface 1000, respectively. The example companion interface 1100 includes bid buttons 1114 to sell at the bid identified at the trading interface 1000. The example buttons 1112a-b and 1114 include function identifiers 1116. The function identifiers 1116 identify function keys of, for example, a keyboard associated with the trading device. The function keys may be selected on a keyboard to perform an automatic function, such as bettering the offer or joining the offer at the trading interface 1000. The example companion interface includes a delete bids button 1118 to delete the bids at the trading interface 1000 and a delete offers button 1120 to delete the offers at the trading interface 1000. The example companion interface 1100 includes a trade out button 1122 to trade out (e.g., to send in orders to offset your current position and “get flat” as well as to delete any currently working orders.) The example companion interface includes a re-center button 1124 to re-center the price level column 1004 at the trading interface 1000. The example companion interface includes control buttons 1126a-c to select which gateway to access (1126a), tradeable object to monitor (1126b) and/or exchange to communicate with (1126c) what trading interface is displayed at the trading device. Any of the buttons 1112a-b to 1126a-c may be selected at the example companion interface 1100 to implement corresponding actions at the trading interface 1000 and/or the trading device.

The example companion interface 1100 includes a lock button 1128 to implement a lock mode at the companion interface 1100. When a user selects the lock button 1128, the companion device continues to display the example companion interface 1100 even when a different trading interface, trading element and/or tradeable object is selected at the trading device. The lock button 1128 may also be used to unlock the companion interface 1100 so that the companion interface 1100 may be updated and/or switched to correspond to new trading interfaces and/or trading elements selected at the trading device.

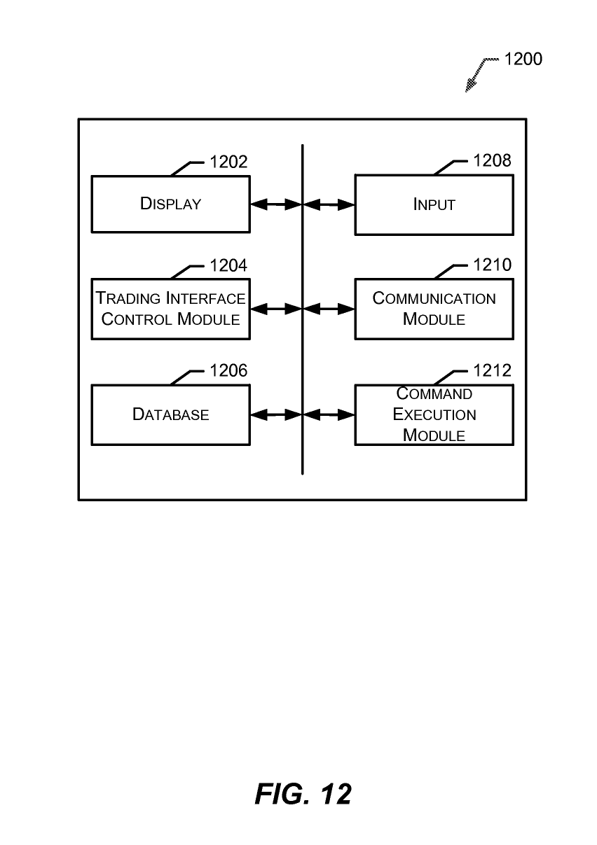

FIG. 12 illustrates a block diagram of an example trading device 1200 to implement the methods of FIGS. 5 and/or 9. The example trading device 1200 is operable with a companion device to enable an electronic trading system. The trading device 1200 may implement a trading interface and/or trading window to facilitate interaction with one or more markets in the trading system. For example, a trading interface implemented at the trading device 1200 may allow a user (e.g., a trader) to obtain and view market data, set order entry parameters, submit order messages to an exchange, deploy trading algorithms, and/or monitor positions while implementing various trading strategies. A trading interface may include trading elements and/or components that make up the trading interface. The trading elements and/or components may be selected by the user at the trading device 1200 to control trading activity (e.g., obtaining market data, setting order entry parameters, submitting order message, and deploying trading algorithms) in the trading interface. The trading device 1200 of the illustrated example includes an example display 1202, an example trading interface control module 1204, an example database 1206, an example input 1208, an example communication module 1210, and an example command execution module 1212.

The display 1202 of the illustrated example displays trading interfaces and/or trading elements at the trading device 1200. The trading interface control module 1204 of the illustrated example controls the trading interfaces and/or trading elements displayed via the display 1202. For example, the trading interface control module 1204 controls the information that is displayed at the trading interface and the layout of the trading interface. The trading interface control module 1206 stores trading interface layouts, definitions of what information is to be included in trading interface at the database 1206. The trading interfaces and/or trading elements may be represented by, for example, selectable buttons, windows, and/or screens, and may be selected at the trading device 1200 by a user via the input 1208.

The input 1208 of the illustrated example may be any input device such as a mouse, and keyboard. The input 1208 of the illustrated example enables a user to select trading interfaces and/or trading elements displayed at the display 1202 and to perform trading actions via the trading interfaces and/or trading elements. The input 1208 allows trading interfaces and/or trading elements to be selected by the user to control trading activity (e.g., obtaining market data, setting order entry parameters, submitting order message, and deploying trading algorithms) in the trading interfaces. The trading interface control module 1204 of the illustrated example implements the trading activity at the trading interfaces and/or trading elements. When trading activity is implemented at the trading interfaces and/or trading elements (e.g., as trading interfaces or trading elements are selected), the trading interface control module 1204 provides information associated with the trading interfaces, trading elements, and/or trading activity to the companion device.

The trading interface control module 1204 of the illustrated example sends trading interface data and/or trading element data corresponding to selected trading interfaces and/or trading elements to the companion device via the communication module 1210. Trading interface data and/or trading element data may include, for example, an identifier of the particular type of trading interface and/or trading element, tradeable object data, historical price charts, current price charts, lists of fills, lists of order activity, pricing details, transaction information, order history, account information, default information, contact information and may be stored at the database 1206. The trading interface data and/or trading element data is used by the companion device to display a companion interface associated with the selected trading interface and/or trading element.

In some examples, the trading interface data and/or trading element data provided to the companion device by the trading interface control module 1204 may be insufficient for the companion device to display the companion interface. For example, the trading interface control module 1204 can send an identifier of a trade order interface corresponding to a trade order interface selected at the trading device, but the companion device may desire and/or require additional information such as a price of the order placed to include in the companion interface to be displayed. In such an example, the companion device may send a request to the trading device 1200 for additional information and/or data.

The communication module 1210 of the illustrated example receives requests for additional information and/or data from the companion device. If a request for additional information and/or data has been received from the companion device, the trading interface control module 1204 collects the requested additional information and/or data. The trading interface control module 1204 may collect the requested additional information from the database 1206. In some examples, the trading interface control module 1204 collects the requested additional information from a gateway and/or an exchange. For example, the trading interface control module 1204 can send a request for information to a gateway and/or an exchange via the communication module 1210. Once the trading interface control module 1204 has collected the requested additional information and/or data, the trading interface control module 1204 sends the requested information and/or data to the companion device that requested the information and/or data via the communication module 1210.

The trading interface control module 1204 determines when actions occur in the trading interface. An action may occur in the trading interface when a user obtains market data, sets order entry parameters, submits order messages to an exchange, deploys trading algorithms, fills an order, and/or monitors positions while implementing various trading strategies. Actions occurring in the trading interface affect (e.g., change) the trading interface data and/or trading element data. If an action has occurred in the trading interface, the trading interface control module 1204 updates the trading interface data and/or trading element data. Updating the trading interface data and/or trading element data may cause the display 1202 to update the display of the trading interface and/or the trading element. The trading interface control module 1204 sends the updated trading interface data and/or trading element data to the companion device via the communication module 1210 to allow the companion device to update the associated companion interface being displayed.

The trading interface control module 1204 also determines when a new trading interface and/or trading element is selected. In some examples, the selection of a new trading interface and/or trading element causes the companion device to switch the companion interface being displayed. If a new trading interface and/or trading element is selected via the input 1208, the trading interface control module 1204 sends trading interface data and/or trading element data associated with the newly selected trading interface and/or trading element to the companion device.

In some examples, the companion device is used to control the trading interface and/or trading elements displayed at the display 1202 of the trading device 1200 to perform trading activities. For example, an indicator of a particular trading interface and/or trading element can be selected at the companion device and the companion device causes the trading device 1200 to display the selected trading interface and/or trading element. In some examples, a trading action (e.g., submitting a trade order) may be implemented at the companion device and the companion device causes the trading device 1200 to execute the trading action and to update a corresponding trading interface and/or trading element according to the executed trading action.

The companion device may send command instructions and the communication module 1210 receives such command instructions. Command instructions are representative of commands to be executed by the trading device 1200. Once a command instruction is received at the communication module 1210, the command execution module 1212 executes the command associated with the command instruction. The command instruction may instruct the trading device 1200 to, for example, select a particular trading interface and/or trading element, obtain and/or view market data, set order entry parameters, submit order messages to an exchange, deploy trading algorithms, and/or monitor positions while implementing various trading strategies. The command execution module 1212 performs the trading action or activity of the command instruction and the trading interface control module 1204 updates a trading interface and/or trading element associated with the trading action or activity. The trading interface control module 1204 updates the trading interface and/or trading element so that the most updated information is displayed at the display 1202.

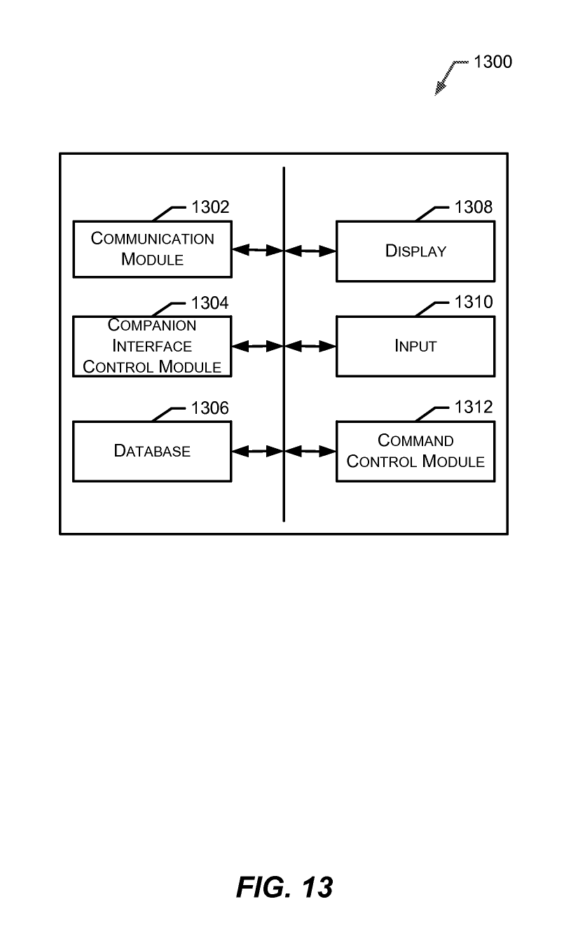

FIG. 13 illustrates a block diagram of an example companion device 1300 to implement the methods of FIGS. 6, 7, and/or 8. The companion device 1300 of the illustrated example is operable with a trading device to provide a user with additional information related to trading activity at the trading device and to enable additional control over the trading activity at the trading device. The example companion device 1300 provides information associated with trading interfaces implemented at the trading device. As a user selects a trading interface and/or an element of a trading interface at the trading device, the companion device 1300 displays a companion interface associated with the selected trading interface and/or trading element. The content and/or format of the companion interface displayed at the example companion device 1300 may depend on the trading interface and/or trading element selected at the trading device. In other words, particular trading interfaces and/or trading elements may be associated with particular companion interfaces. The companion device 1300 of the illustrated example includes an example communication module 1302, an example companion interface control module 1304, an example database 1306, an example display 1308, an example input 1310, and an example command control module 1312.

The companion device 1300 receives trading interface data and/or trading element data from the trading device via the communication module 1302. The trading interface data and/or trading element data corresponds to a trading interface and/or trading element selected at the trading device. Trading interface data and/or trading element data may include, for example, an identifier of the particular type of trading interface and/or trading element, tradeable object data, historical price charts, current price charts, lists of fills, lists of order activity, pricing details, transaction information, order history, account information, default information, and contact information.

The companion interface control module 1304 identifies a type of trading interface and/or trading element selected at the trading device using the trading interface data and/or the trading element data. For example, the companion interface control module 1304 can identify the type of trading interface and/or trading element using an identifier included in the data received from the trading device. In the illustrated example, the companion device 1300 includes the database 1306 to store trading interface and/or trading element identifiers along with the corresponding type of trading interface and/or trading element.

The companion interface control module 1304 selects a companion interface corresponding to the identified type of trading interface and/or trading element. In the illustrated example, the database 1306 stores layouts for the various types of companion interfaces associated with the different types of selected trading interfaces and/or trading elements. The layouts for the various types of companion interfaces may define particular trading data to be included in the companion interface, location of particular trading data in the companion interface, control elements (e.g., selectable buttons) to be included in the companion interface. In some examples, companion interfaces to provide information related to a tradeable object include historical price charts, current price charts, lists of fills, lists of order activity, and details about current pricing (e.g., high prices, low prices, and close prices). In some examples, companion interfaces to provide information related to a trade order include transaction information, order history (e.g., actions implemented in association with the trade order), and tradeable object information. In some examples, companion interfaces to provide information related to a trade fill include transaction information, order history (e.g., actions implemented in association with the trade order), and tradeable object information. In some examples, companion interfaces to provide information related to user credentials may include account information, customer accounts, default information, and contact information.

The companion interface control module 1304 determines if additional information and/or data is needed to implement the identified companion interface. In some examples, the trading interface data and/or trading element data provided by the trading device may be insufficient to create the companion interface associated with the trading interface and/or trading element selected at the trading device. For example, the trading device can send an identifier of a trade order interface corresponding to a trade order interface selected at the trading device, but the companion interface control module 1304 may desire and/or require additional information such as a price of the order placed to include in the companion interface to be displayed.

The companion interface control module 1304 may send a request to the trading device for the additional data and/or information via the communication module 1302. In some examples, the companion interface control module 1304 sends the request for the additional data and/or information to a gateway and/or an exchange via the communication module 1302. The communication module 1302 receives the requested additional data and/or information and the interface control module displays the trading interface with the appropriate trading interface data and/or trading element data via the display 1308.

The companion device 1300 may receive updated trading interface data and/or trading element data via the communication module 1302 as trading activities or actions occur at the trading device. Trading actions may occur in a trading interface at the trading device when a user obtains market data, sets order entry parameters, submits order messages to an exchange, deploys trading algorithms, fills an order, and/or monitors positions while implementing various trading strategies, etc. If the communication module 1302 receives updated trading interface data and/or trading element data, the companion interface control module 1304 displays the companion interface with the updated trading interface data and/or trading element data via the display 1308.

The companion interface control module 1304 determines if new trading interface data and/or new trading element data has been received from the trading device via the communication module 1302. New trading interface data and/or new trading element data indicates that a new trading interface and/or trading element has been selected at the trading device. If new trading interface data and/or new trading element data has been received at the communication module 1302, the companion interface control module 1304 identifies the new trading interface and/or trading element type and displays a new companion interface corresponding to the new trading interface and/or trading element via the display 1308.

In some examples, as a user selects a new and/or different trading interface and/or trading element at the trading device, the companion device 1300 dynamically switches the companion interface being displayed to correspond to the selected new and/or different trading interface and/or trading element. In some examples, the user may wish to select a new and/or different trading interface and/or trading element at the trading device, but may wish for the companion interface displayed at the companion device 1300 to remain the same. For example, the user may wish to use the information displayed on the companion device 1300 for reference when interacting with a different trading interface and/or trading element at the trading device. To enable the companion interface to be continuously displayed at the companion device 1300 despite the selection of a different trading interface at the trading device, the companion device 1300 implements a lock mode.

The companion interface control module 1304 determines if a lock mode selection has been received via the input 1310. In some examples, the companion interface control module 1304 provides a selectable lock mode button in the companion interface to enable a user to select the lock mode via the input 1310. If a lock mode selection has been received, the companion interface control module 1304 locks the display of the currently displayed companion interface (e.g., the companion interface being displayed when the lock mode was selected by the user). By locking the companion interface, the companion interface control module 1304 does not dynamically switch the companion interface being displayed even when data received from the trading device indicates that a new trading interface and/or trading element has been selected. In some examples, the companion interface control module 1304 may not switch the display 1308 to a new companion interface, but may update data being displayed at the current companion interface based on data received from the trading device.

The companion interface control module 1304 also determines if an unlock mode selection has been received. In some examples, when the companion interface control module 1304 is in a lock mode, the companion interface control module 1304 provides a selectable unlock mode button in the companion interface to enable the user to select the unlock mode via the input 1310. If an unlock mode selection has been received, the companion interface control module 1304 displays a new companion interface corresponding to the new trading interface data and/or trading element data received from the trading device at the display 1308.

The command control module 1312 of the illustrated example may be used to implement trading activity at the trading device. Trading activity may include, for example, obtaining and/or viewing market data, setting order entry parameters, submitting order messages to an exchange, deploying trading algorithms, and/or monitoring positions while implementing various trading strategies. The command control module 1312 may be used to control a trading interface and/or trading element displayed at the trading device to perform trading activities. For example, an indicator of a particular trading interface and/or trading element can be selected via the input 1310 and the companion device 1300 causes the trading device to display the selected trading interface and/or trading element. In some examples, a trading action (e.g., submitting a trade order) may be implemented at the companion device 1300 via the input 1310 and the companion device 1300 causes the trading device to execute the trading action and to update a corresponding trading interface and/or trading element according to the executed trading action.

The command control module 1312 determines if user input has been received via the input 1310 to initiate a trading activity. In some examples, the companion interface control module 1304 provides selectable buttons and/or windows in the companion interface to enable a user to select commands, input parameters to execute trading activities or actions via the input 1310. Once user input has been received via the input 1310, the command control module 1312 finds command instructions associated with the user input. The database 1306 stores user inputs and command instructions associated with the user input. For example, if a user selects a button in the companion interface to submit a trading order, the command control module 1312 searches the database 1306 for a command instruction to provide to the trading device to cause the trading device to submit the trade order according to the user input. Once the command control module 1312 finds the command instruction for the user input, the command control module 1312 sends the command instruction to the trading device via the communication module 1302 to cause the trading device to execute the command instruction.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

What is claimed is:

1. A method comprising:
identifying, at a first trading device, a first trading interface selected at a second trading device, the first trading interface including first trading data;
displaying a first companion interface at the first trading device, the first companion interface associated with the first trading interface;
determining whether to update the first companion interface or to display a second companion interface based on activity at the second trading device;
updating the first companion interface if the first trading data is altered at the first trading interface; and
displaying a second companion interface at the first trading device if a second trading interface is selected at the second trading device, the second companion interface associated with the second trading interface.

2. The method of claim 1, wherein the first companion interface includes second trading data related to the first trading data.

3. The method of claim 1, further comprising requesting second trading data from the second trading device to be included in the first companion interface, the second trading data related to the first trading data.

4. The method of claim 1, further comprising:
identifying, at the first trading device, a third trading interface selected at the second trading device;
determining if the first trading device is in a lock mode, the lock mode implemented by a user;
displaying a third companion interface at the first trading device if the first trading device is not in a lock mode; and
displaying the first companion interface at the first trading device if the first trading device is in a lock mode.

5. The method of claim 1, further comprising:
identifying a command instruction at the first trading device, the command instruction corresponding to an input received by a user; and
sending the command instruction to the second trading device, the command instruction to implement activity at the second trading device.

6. The method of claim 5, wherein the activity includes selecting a third trading interface.

7. The method of claim 1, wherein the first trading device is a handheld computing device.

8. A system comprising:
a computing device configured to:
identify a first trading interface selected at a first trading device, the first trading interface including first trading data;
display a first companion interface, the first companion interface associated with the first trading interface;
determine whether to update the first companion interface or to display a second companion interface based on activity at the first trading device;
update the first companion interface if the first trading data is altered at the first trading interface; and
display the second companion interface if a second trading interface is selected at the first trading device, the second companion interface associated with the second trading interface.

9. The system of claim 8, wherein the first companion interface includes second trading data related to the first trading data.

10. The system of claim 8, wherein the computing device is further configured to request second trading data from the first trading device to be included in the first companion interface, the second trading data related to the first trading data.

11. The system of claim 8, wherein the computing device is further configured to:
identify a third trading interface selected at the first trading device;
determine if a lock mode is implemented, the lock mode selected by a user;
display a third companion interface if the lock mode is not implemented; and
display the first companion interface if the lock mode is implemented.

12. The system of claim 8, wherein the computing device is further configured to:
identify a command instruction, the command instruction corresponding to an input received by a user; and
send the command instruction to the first trading device, the command instruction to implement activity at the first trading device.

13. The system of claim 8, wherein the computing device is a handheld computing device.

14. A tangible computer readable storage medium comprising instructions that, when executed, cause a computing device to at least:
identify, at a first trading device, a first trading interface selected at a second trading device, the first trading interface including first trading data;
display a first companion interface at the first trading device, the first companion interface associated with the first trading interface;
determine whether to update the first companion interface or to display a second companion interface based on activity at the second trading device;
update the first companion interface if the first trading data is altered at the first trading interface; and
display a second companion interface at the first trading device if a second trading interface is selected at the second trading device, the second companion interface associated with the second trading interface.

15. The computer readable storage medium of claim 14, wherein the first companion interface includes second trading data related to the first trading data.

16. The computer readable storage medium of claim 14, further comprising instructions that cause the computing device to request second trading data from the second trading device to be included in the first companion interface, the second trading data related to the first trading data.

17. The computer readable storage medium of claim 14, further comprising instructions that cause the computing device to:
identify, at the first trading device, a third trading interface selected at the second trading device;
determine if the first trading device is in a lock mode, the lock mode implemented by a user;
display a third companion interface at the first trading device if the first trading device is not in a lock mode; and
display the first companion interface at the first trading device if the first trading device is in a lock mode.

18. The computer readable storage medium of claim 14, further comprising instructions that cause the computing device to:
identify a command instruction at the first trading device, the command instruction corresponding to an input received by a user; and
send the command instruction to the second trading device, the command instruction to implement activity at the second trading device.

19. The computer readable storage medium of claim 18, wherein the activity includes selecting a third trading interface.

20. The computer readable storage medium of claim 14, wherein the first trading device is a handheld computing device.
